(19) United States
(12) Patent Application Publication
(10) Pub. No.: US 2005/0281226 A1
(43) Pub. Date: Dec. 22, 2005

(54) Apparatus and method for feedback of channel quality information in communication systems using an OFDM scheme

(75) Inventors: Yong-Hwan Lee, Seoul (KR); Zhong-Hai Han, Suwon-si (KR)

Correspondence Address: DILWORTH & BARRESE, LLP, 333 EARLE OVINGTON BLVD., UNIONDALE, NY, 11553, US

(73) Assignees: SAMSUNG ELECTRONICS CO., LTD., Suwon-si (KR); Seoul National University Industry Foundation, Seoul (KR)

(21) Appl. No.: 11/152,428

(22) Filed: Jun. 14, 2005

(30) Foreign Application Priority Data
Jun. 16, 2004 (KR) 10-2004-0044723

(51) Int. Cl. H04L 12/26; H04Q 7/00

(52) U.S. Cl. 370/329; 370/278; 370/252

(57) ABSTRACT

Disclosed is a method for MS channel quality information to feed back in a communication system which divides an entire frequency band into a plurality of sub-carrier bands and includes sub-channels representing a set of a predetermined number of sub-carrier bands. The method includes measuring channel qualities of the sub-channels, arranging the sub-channels in a sequence in which a sub-channel having channel quality conditions precedes any other sub-channels, selecting sub-channels satisfying preset conditions from the arranged sub-channels, and feeding back channel quality information of the selected sub-channels.

### PRIORITY

This application claims priority under 35 U.S.C. § 119 to an application entitled “Apparatus and Method for Feedback of Channel Quality Information in Communication System using OFDM scheme” filed in the Korean Intellectual Property Office on Jun. 16, 2004 and assigned Ser. No. 2004-44723, the contents of which are hereby incorporated by reference.

### BACKGROUND OF THE INVENTION

1. Field of the Invention

The present invention relates to a communication system using an Orthogonal Frequency Division Multiplexing (OFDM) scheme, and more particularly to an apparatus and method for feedback of channel quality information.

2. Description of the Related Art

In general, when large amounts of data are transmitted through a radio channel, a high Bit Error Rate (BER) occurs due to multi-path fading, a Doppler spread, etc. To compensate, a spread spectrum modulation scheme is widely used for high speed transmission of large amounts of data because it has relatively low transmit power, relatively low detection probability, etc.

The spread spectrum scheme may be classified into a Direct Sequence Spread Spectrum (DSSS) scheme and a Frequency Hopping Spread Spectrum (FHSS) scheme. The DSSS scheme is a scheme for acquiring path diversity gain by using a Rake receiver. Further, the DSSS scheme may be efficiently used at a transmission speed of 10 Mbps. However, the DSSS scheme has disadvantages in that inter-chip interference and hardware complexity increases, and capacities of users are restricted due to multi-user interference when the DSSS scheme transmits data at a speed of more than 10 Mbps.

The FHSS scheme is capable of reducing the influence of multi-channel interference and narrow band impulse noise by transmitting data through change of frequency by a random sequence. However, the FHSS scheme has a disadvantage in that it is difficult to acquire exact synchronization between a transmitter and a receiver when data is transmitted at a high speed.

The OFDM scheme has been widely researched as a proper scheme for high speed transmission of data through a wired/wireless channel. The OFDM scheme, which transmits data using multi-carriers, is a special type of a Multiple Carrier Modulation (MCM) scheme in which a serial symbol sequence is converted into parallel symbol sequences and the parallel symbol sequences are modulated with a plurality of mutually orthogonal sub-carriers before being transmitted.

In a communication system using the OFDM scheme (OFDM communication system), the structure of a frequency domain of a symbol is defined by sub-carriers. The sub-carriers may be classified into data sub-carriers used for data transmission, pilot sub-carriers used for transmission of a symbol of a preset specific pattern for various estimations, and null sub-carriers for a guard interval and a DC component. The data sub-carriers and the pilot sub-carriers, are effective sub-carriers.

An Orthogonal Frequency Division Multiplex Access (OFDMA) scheme divides the effective sub-carriers into multiple sets of sub-carriers, that is, sub-channels, for use. The sub-channel represents a channel constructed by one or more sub-carriers and the sub-carriers included in the sub-channel may be adjacent to each other and vice versa. A communication system (OFDMA communication system) using the OFDMA scheme may simultaneously provide service to a plurality of users.

The OFDM scheme and the OFDMA scheme are similar to a conventional Frequency Division Multiplexing (FDM) scheme, but can achieve the optimal transmission efficiency in high speed transmission by transmitting a plurality of sub-carriers while maintaining orthogonality therebetween. Further, the OFDM scheme or the OFDMA scheme is quite efficient in its use of frequencies and is tolerant to multi-path fading, thereby achieving the optimal transmission efficiency in high speed transmission.

Furthermore, since the OFDM scheme and the OFDMA scheme uses an overlapping frequency spectrum, it is quite efficient in its use of frequencies and is tolerant to frequency selective fading and multi-path fading. Moreover, the OFDM scheme or the OFDMA scheme can reduce Inter-Symbol Interference (ISI) by using a guard interval, enables the hardware structure of an equalizer to be simply designed, and is tolerant to impulse noise. Consequently, the OFDM scheme and the OFDMA scheme have been widely employed in communication systems.

FIG. 1 is a block diagram illustrating a transmitter and a receiver used in a conventional OFDM communication system.

Referring to FIG. 1, the OFDM communication system includes the transmitter 100 and the receiver 150. The transmitter 100 may be a Base Station (BS) and the receiver 150 may be a Mobile Station (MS). The transmitter 100 includes a coder 104, a symbol mapper 106, a serial-to-parallel converter 108, a pilot symbol inserter 110, an Inverse Fast Fourier Transform (IFFT) unit 112, a parallel-to-serial converter 114, a guard interval inserter 116, a digital-to-analog converter (D/A converter) 118, and a Radio Frequency (RF) processor 120.

The coder 104 receives a user data information bit and a control data information bit, codes the received bits by means of a preset coding scheme, and outputs the coded bits to the symbol mapper 106. The coding scheme may include a turbo coding scheme having a predetermined coding rate, a convolutional coding scheme, etc. The symbol mapper 106 generates serial modulation symbols by modulating the coded bits output from the coder 104 by means of a preset modulation scheme, and outputs the serial modulation symbols to the serial-to-parallel converter 108. For example, the modulation scheme may use a Binary Phase Shift Keying (BPSK), a Quadrature Phase Shift Keying (QPSK), a 16 Quadrature Amplitude Modulation (QAM), a 64 QAM, etc.

The serial-to-parallel converter 108 converts the serial modulation symbols into parallel modulation symbols, and outputs the parallel modulation symbols to the pilot symbol inserter 110. The pilot symbol inserter 110 inserts pilot symbols into the parallel modulation symbols, and outputs the symbols (i.e., predetermined signals) including the pilot symbols to the IFFT unit 112. The IFFT unit 112 performs an N-point IFFT for the received signals, and outputs predetermined signals to the parallel-to-serial converter 114.

The parallel-to-serial converter 114 performs a serial conversion on the received signals, and outputs serial-converted signals to the guard interval inserter 116. The guard interval inserter 116 inserts guard interval signals into the received signals, and outputs predetermined signals to the D/A converter 118.

The guard interval is inserted to remove interference between the OFDM symbol transmitted in the previous OFDM symbol time and the current OFDM symbol to be transmitted in the current OFDM symbol time when the OFDM communication system transmits the OFDM symbol. Further, the guard interval is inserted by one of a cyclic prefix scheme, which copies predetermined last samples of an OFDM symbol on a time domain and inserts the predetermined last samples into effective OFDM symbols, or a cyclic postfix scheme which copies predetermined initial samples of the OFDM symbol on the time domain and inserts the predetermined initial samples into the effective OFDM symbols.

The D/A converter 118 converts the received signals into analog signals, and outputs the analog signals to the RF processor 120. The RF processor 120 includes a filter, a front end unit, etc., and converts the analog signals into RF signals capable of being transmitted to the air, and transmits the RF signals to the air through a transmission antenna (Tx antenna).

The receiver 150 includes an RF processor 152, an analog-to-digital converter (A/D converter) 154, a guard interval remover 156, a serial-to-parallel converter 158, a Fast Fourier Transform (FFT) unit 160, a pilot symbol extractor 162, a channel estimator 164, an equalizer 166, a parallel-to-serial converter 168, a symbol demapper 170, and a decoder 172.

First, the signals output from the transmitter 100 are attenuated by noise through a multi-path channel and are received through a reception antenna (Rx antenna) of the receiver 150. The signals are input to the RF processor 152. The RF processor 152 down-converts the received signals into analog signals in an intermediate frequency band, and outputs the analog signals to the A/D converter 154. The A/D converter 154 converts the analog signals output from the RF processor 152 into digital signals, and outputs the digital signals to the guard interval remover 156.

The guard interval remover 156 removes the guard interval signals, and outputs serial signals to the serial-to-parallel converter 158. The serial-to-parallel converter 158 performs a parallel conversion for the serial signals, and outputs the parallel-converted signals to the FFT unit 160. The FFT unit 160 performs an N-point FFT for the signals output from the serial-to-parallel converter 158, and outputs predetermined signals to the equalizer 166 and the pilot symbol extractor 162. The equalizer 166 performs channel equalization for the received signals, and outputs parallel signals to the parallel-to-serial converter 168. The parallel-to-serial converter 168 performs a serial conversion for the parallel signals, and outputs the serial-converted signals to the symbol demapper 170.

Further, the signals output from the FFT unit 160 are input to the pilot symbol extractor 162. The pilot symbol extractor 162 detects the pilot symbols from the signals output from the FFT unit 160, and outputs the detected pilot symbols to the channel estimator 164. The channel estimator 164 performs a channel estimation by means of the pilot symbols output from the pilot symbol extractor 162, and outputs a result from the channel estimation to the equalizer 166. The receiver 150 generates channel quality information corresponding to the result from the channel estimation by the channel estimator 164, and transmits the generated channel quality information to the transmitter 100 through a channel quality information transmitter. For example, the channel quality information may include a Carrier-to-Interference and Noise Ratio (CINR), an average value and a standard variation value of Receive Signal Strength Indicator (RSSI), etc.

The symbol demapper 170 demodulates the signals from the parallel-to-serial converter 168 by means of a corresponding demodulation scheme, and outputs the demodulated signals to the decoder 172. The decoder 172 decodes the signals output from the symbol demapper 170 by means of a preset decoding scheme, and outputs the decoded signals. The demodulation scheme and the decoding scheme correspond to the modulation scheme and the coding scheme used in the transmitter 100, respectively.

To support the high speed data transmission as described above, various schemes have been used. More specifically, an Adaptive Modulation and Coding (AMC) scheme has been used. The AMC scheme represents a data transmission scheme for determining different modulation schemes and coding schemes according to channel conditions of a cell, that is, between a BS and an MS, thereby improving the entire use efficiency of the cell. The AMC scheme includes a plurality of modulation schemes and a plurality of coding schemes, and modulates and codes channel signals by combining the modulation schemes and the coding schemes.

Typically, each combination of the modulation schemes and the coding schemes will be referred to as a Modulation and Coding Scheme (MCS), and multiple MCSs from a level 1 to a level N may be defined according to the number of the MCSs. That is, the AMC scheme adaptively determines the level of the MCS according to channel conditions between the MS and a BS to which the MS is connected in a wireless manner, thereby improving the entire system efficiency of the BS.

As described above, in the OFDM communication system or the OFDMA communication system, the MS must inform its corresponding BS of channel conditions (i.e. channel quality information) of a downlink. However, when a plurality of MSs feedback the channel quality information to the BS in each predetermined period, overload may occur due to the feedback of the channel quality information. Accordingly, it is desirable to provide a channel quality information feedback scheme capable of reducing the overload due to the feedback of the channel quality information and exactly reporting the channel quality information.

### SUMMARY OF THE INVENTION

Accordingly, the present invention has been made to solve the above-mentioned problems occurring in the prior art, and it is an object of the present invention to provide an apparatus and a method for efficiently feeding back channel quality information in an OFDM communication system.

It is another object of the present invention to provide an apparatus and a method for feeding back channel conditions of channels having relatively good channel quality as channel quality information in an OFDM communication system.

In order to accomplish the aforementioned object, according to one aspect of the present, there is provided a method for a Mobile Station (MS) to feed back channel quality information in a communication system which divides an entire frequency band into a plurality of sub-carrier bands and includes sub-channels representing a set of a predetermined number of sub-carrier bands, the method including measuring channel qualities of the sub-channels; arranging the sub-channels in a sequence in which a sub-channel having channel quality conditions precedes any other sub-channels; selecting sub-channels satisfying preset conditions from the arranged sub-channels; and feeding back channel quality information of the selected sub-channels.

In order to accomplish the aforementioned object, according to one aspect of the present, there is provided an apparatus to feed back channel quality information in a communication system which divides an entire frequency band into a plurality of sub-carrier bands and includes sub-channels representing a set of a predetermined number of sub-carrier bands, the apparatus including a channel estimator for measuring channel qualities of the sub-channels; a sub-channel arranging unit for arranging sub-channels in a sequence in which a sub-channel having channel quality conditions precedes any other sub-channels; a sub-channel selector for selecting sub-channels satisfying preset conditions from the arranged sub-channels; and a channel quality information transmitter to feed back channel quality information of the selected sub-channels.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the general structures of a transmitter and a receiver used in an OFDM communication system;

FIG. 2 is a block diagram illustrating a structure of a receiver in an OFDM communication system according to an embodiment of the present invention;

FIG. 3 is a graph with a matrix form, which schematically illustrates channel quality information transmitted from a plurality of MSs according to an embodiment of the present invention;

FIG. 4 is a graph with a matrix form, which schematically illustrates a result after a BS assigns sub-channels to each MS in an OFDM communication system according to an embodiment of the present invention;

FIG. 5 is a flow diagram illustrating a channel quality information feedback process by an MS in an OFDM communication system according to an embodiment of the present invention;

FIG. 6 is a block diagram illustrating the structure of a channel filter according to an embodiment of the present invention; and

FIG. 7 is a graph that illustrates a comparison of transmission performance between an existing scheme and a scheme proposed by the present invention when quality information of some sub-channels is fedback.

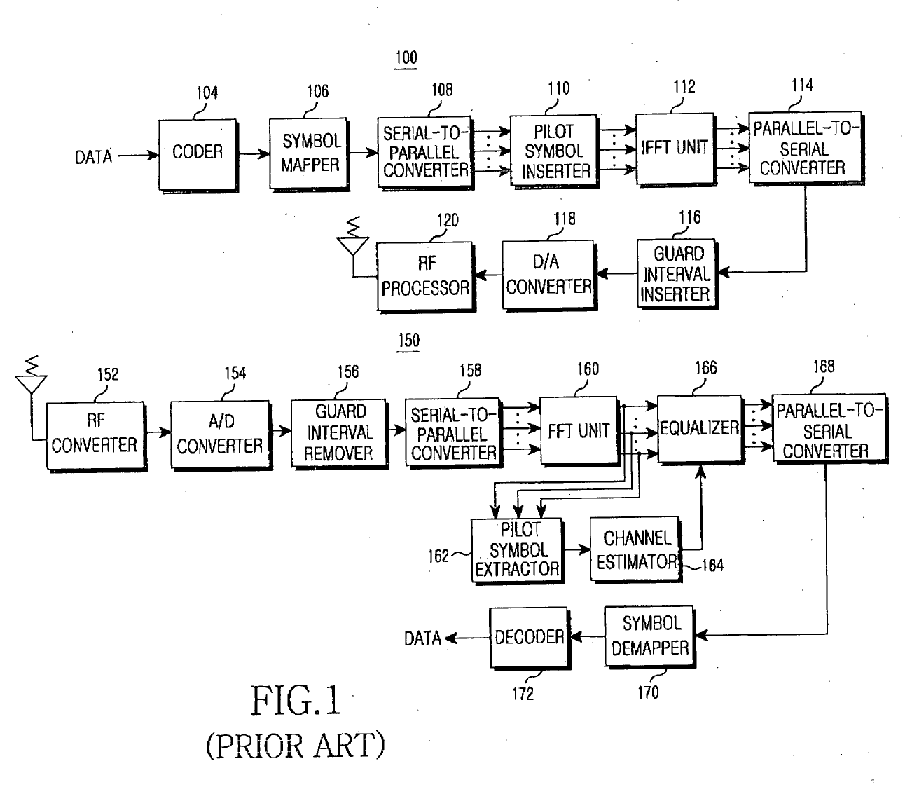

### DETAILED DESCRIPTION OF THE PREFERRED EMBODIMENT

A preferred embodiment of the present invention will be described in detail herein below with reference to the accompanying drawings. In the following description, a detailed description of known functions and configurations incorporated herein will be omitted when it may obscure the subject matter of the present invention.

The present invention proposes a scheme in which an MS feeds back channel quality information to a BS for a preset number of channels having good channel conditions in an OFDM communication system. That is, in the present invention, the MS receives signals transmitted from the BS through a common channel, measures channel conditions by means of pilots included in the received signals, and feeds back the measured channel conditions to the BS. The MS measures channel quality for each sub-channel which is a set of one or more sub-carriers. The MS feeds back channel quality information for a preset number of measured sub-channels to the BS according to a sequence in which a sub-channel having the best channel condition precedes any other sub-channels from among the preset number of measured sub-channels.

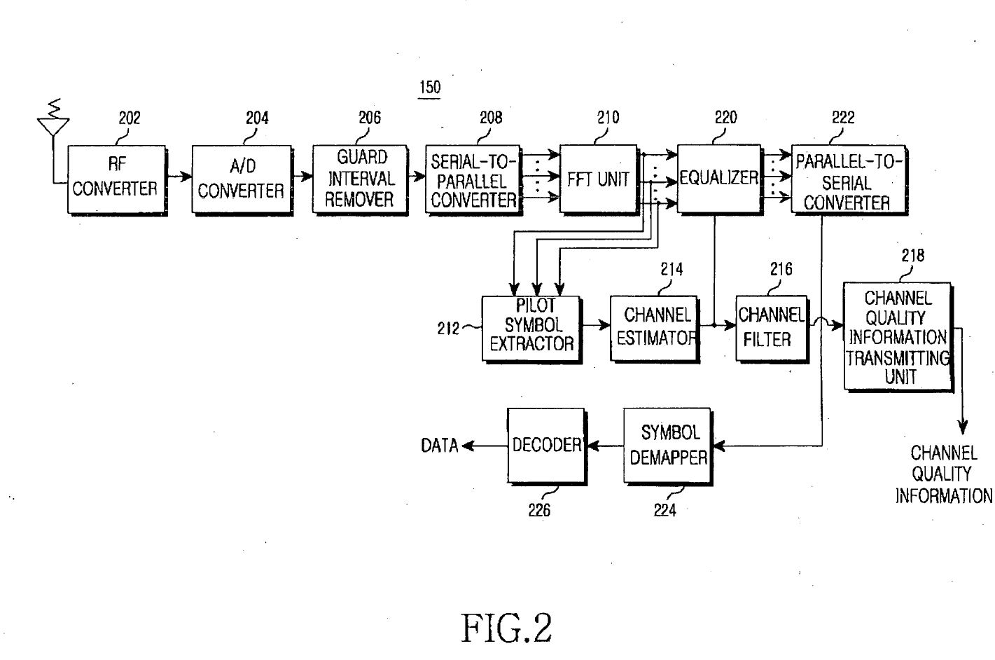

FIG. 2 is a block diagram illustrating the structure of a receiver in an OFDM communication system according to an embodiment of the present invention.

The receiver (i.e., MS) measures channel quality information for each sub-channel by means of signals transmitted from a BS, and feeds back channel quality information of sub-channels having good channel conditions according to a result from the measurement. The number of sub-channels having good channel conditions may be variably set according to circumstances of the OFDM communication system.

Referring to FIG. 2, the receiver includes an RF processor 202, an A/D converter 204, a guard interval remover 206, a serial-to-parallel converter 208, an FFT unit 210, a pilot symbol extractor 212, a channel estimator 214, a channel filter 216, a channel quality information transmitting unit 218, an equalizer 220, a parallel-to-serial converter 222, a symbol demapper 224, and a decoder 226.

First, the signals output from the transmitter are attenuated by noise while traveling a multi-path channel and are received through a reception antenna (Rx antenna) of the receiver. The received signals are input to the RF processor 202. The RF processor 202 down-converts the received signals into analog signals in an intermediate frequency band, and outputs the analog signals to the A/D converter 204. The AID converter 204 converts the analog signals into digital signals, and outputs the digital signals to the guard interval remover 206.

The guard interval remover 206 removes the guard interval signals, and outputs serial signals to the serial-to-parallel converter 208. The serial-to-parallel converter 208 performs a parallel conversion for the serial signals, and outputs the parallel-converted signals to the FFT unit 210. The FFT unit 210 performs an N-point FFT for the signals output from the serial-to-parallel converter 208, and outputs predetermined signals to the equalizer 220 and the pilot symbol extractor 212.

The equalizer 220 performs channel equalization for the received signals, and outputs parallel signals to the parallel-to-serial converter 222. The parallel-to-serial converter 222 performs a serial conversion for the parallel signals, and outputs the serial-converted signals to the symbol demapper 224.

The signals output from the FFT unit 210 are also input to the pilot symbol extractor 212. The pilot symbol extractor 212 detects the pilot symbols from the signals output from the FFT unit 210, and outputs the detected pilot symbols to the channel estimator 214. The channel estimator 214 performs a channel estimation by means of the pilot symbols output from the pilot symbol extractor 212, and outputs a result from the channel estimation to the equalizer 220 and the channel filter 216. Further, the channel estimator 214 generates channel quality information according to each sub-channel corresponding to the result from the channel estimation, and transmits the generated channel quality information to the channel filter 216. For example, the channel quality information may include a CINR, an average value and a standard variation value of RSSI, etc.

The channel filter 216, after receiving the channel quality information for each sub-channel from the channel estimator 214, selects some sub-channels having good channel quality conditions from all sub-channels according to a predetermined criterion, and transmits information on the selected sub-channels to the channel quality information transmitting unit 218. The information represents indices of the sub-channels, location information in frames of the sub-channels, etc.

In the present invention, the receiver may measure channel quality information for the entire sub-channels, sequentially select sub-channels satisfying a predetermined criterion (i.e., a reference critical value), and feedback the channel quality information of the selected sub-channels to the BS. Otherwise, the receiver may measure channel quality information only for the predetermined number of sub-channels of the entire sub-channels, and feedback the measured channel quality information to the BS. The preferred embodiment of the present invention is described as it related to the case where channel quality information for the predetermined number of sub-channels, for example, N number of sub-channels (or sub-carriers), are fedback according to a sequence in which a sub-channel having good channel conditions precedes any other sub-channels.

In one embodiment, it is assumed that an entire sub-carrier band is grouped in five sub-channels, and an MS measures channel quality information of the five sub-channels and transmits the channel quality information of the three sub-channels having good sub-channel conditions to a BS. A random MS measures the channel quality information of the five sub-channels by means of pilot signals transmitted from the BS. As a result of the measurement, when the sub-channels have good channel quality conditions in a sequence of a first sub-channel, a fourth sub-channel, a third sub-channel, a second sub-channel and a fifth sub-channel, the MS feeds back the channel quality information of the first sub-channel, the fourth sub-channel and the third sub-channel to the BS.

In another embodiment, there is a method for the MS to feedback channel quality information for sub-channels satisfying a reference critical value. Accordingly, the channel filter 216 may feedback the channel quality information of the first sub-channel and the fourth sub-channel satisfying the reference critical value. If there is no sub-channel satisfying the reference critical value, the MS transmits channel quality information of the preset number of sub-channels as described in the one embodiment.

In an alternative embodiment, the case where channel quality information is fedback by a plurality of MSs are different from one another will be described. That is, it is assumed that a first MS feeds back channel quality information for a first sub-channel, a second MS feeds back channel quality information for a second sub-channel, a third MS feeds back channel quality information for a third sub-channel, a fourth MS feeds back channel quality information for a fourth sub-channel, and a fifth MS feeds back channel quality information for a fifth sub-channel. In the above embodiments, it is assumed that one MS feeds back quality information for one stationary sub-channel. However, one MS may feedback quality information for two or more sub-channels. Then, each of the MSs measures channel quality information only for a sub-channel designated to the MS and feeds back the measured channel quality information to the BS. The BS having received the channel quality information for each sub-channel from each MSS, performs a scheduling of sub-channels to be assigned to the MSs in consideration of the received channel quality information, Quality of Service (QoS) levels of the MSs, etc.

The symbol demapper 224 demodulates the signals output from the parallel-to-serial converter 222 by means of a corresponding demodulation scheme, and outputs the demodulated signals to the decoder 226. The decoder 226 decodes the signals output from the symbol demapper 224 by means of a corresponding decoding scheme, and outputs the decoded signals. The demodulation scheme and the decoding scheme correspond to the modulation scheme and the coding scheme used in the transmitter 100, respectively.

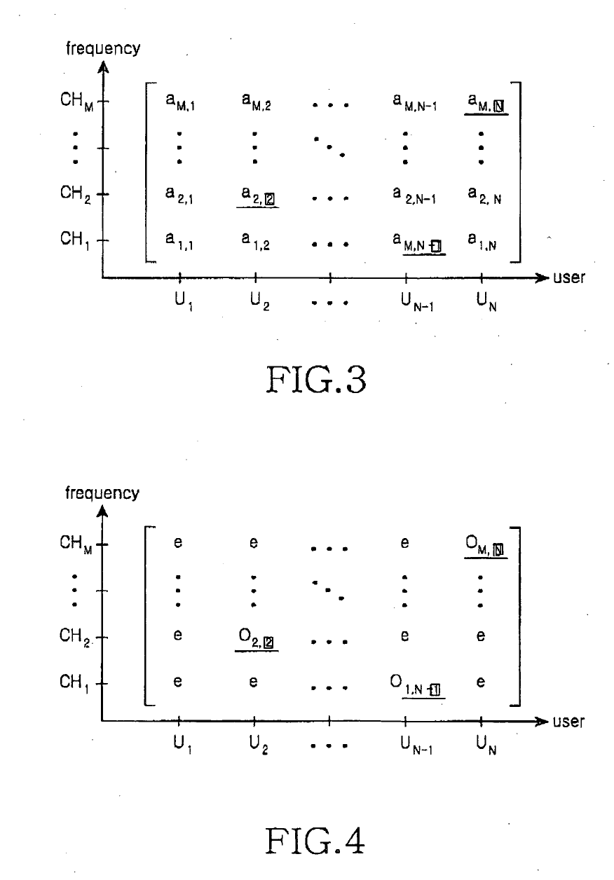

FIG. 3 is a graph with a matrix form, which schematically illustrates channel quality information transmitted from a plurality of MSs according to an embodiment of the present invention.

Referring to FIG. 3, the horizontal axis represents MSs U₁˜U_{N}, that is, users, and the vertical axis represents a frequency band (sub-channel unit). The MSs measure channel quality information for each sub-channel by means of pilot signals transmitted from the transmitter. A random MS may also feedback quality information of all sub-channels satisfying a reference critical value or may also feedback quality information of the predetermined number of sub-channels. That is, the random MS may also feedback quality information of a sub-channel having the most good channel quality conditions. Further, the random MS arranges the sub-channels in a sequence in which a sub-channel having good channel quality conditions precedes any other sub-channels, and may transmit quality information of the predetermined number of sub-channels. In the a_{M,N} of FIG. 3, the ‘a’ may represent a CINR or different variable values according to each MSS. Further, the M represents the sub-channel and the N represents an identifier of an MSS having fedback the channel quality information.

FIG. 4 is a graph with a matrix form, which schematically illustrates the result after a BS assigns sub-channels to each MSS in an OFDM communication system according to an embodiment of the present invention.

Referring to FIG. 4, the horizontal axis represents MSs, that is, users, and the vertical axis represents a frequency band (sub-channel unit). In FIG. 4, it is assumed that each MSS selects a sub-channel having the most good channel quality and feeds back the selected sub-channel to the BS. That is, each MS measures channel quality for each sub-channel and feeds back quality information for one sub-channel having the most good channel quality to the BS. The BS, having received the channel quality information fedback from the MSs, performs a scheduling for the sub-channel assignment according to each MS. If the MS transmits the channel quality information for one sub-channel to the BS, the BS assigns the one sub-channel to the MS. However, when two or more MSs select the same sub-channel and feedback the selected sub-channel to the BS, the BS assigns the sub-channel based on priority. For example, the BS may assign the sub-channel to an MS having transmitted channel quality information with the higher CINR value to determine priority.

In the above description, the BS determines the sub-channel assignment based on the CINR value. However, the BS may also take different Quality of Service (QoS) into consideration according to each MS or may also determine the sub-channel assignment by combining other information. The ‘e (empty)’ of FIG. 4 represents that there is no MS having selected a corresponding sub-channel channel for each sub-channel, and the ‘0’ represents channel quality information values transmitted from the MSs. Accordingly, the ‘0’ may also be the CINR value or may be a value determined by considering the CINR and other information.

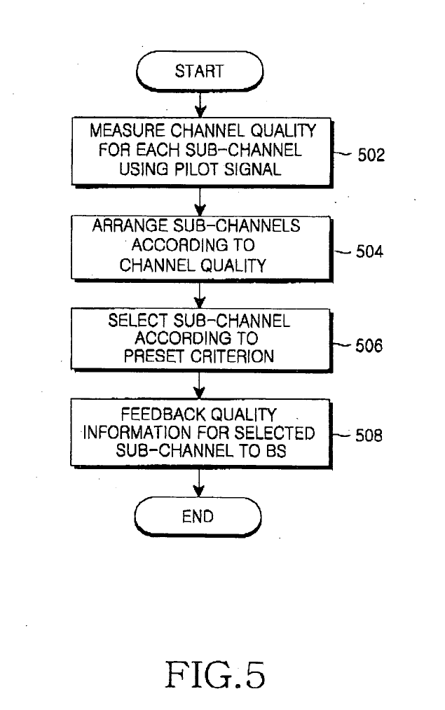

FIG. 5 is a flow diagram illustrating a channel quality information feedback process by an MS in an OFDM communication system according to an embodiment of the present invention.

Referring to FIG. 5, in step 502, the MS measures channel quality for each sub-channel by means of pilot signals from among signals received from a BS. In step 504, the MS sequentially arranges the sub-channels in such a manner that a sub-channel having good channel quality precedes any other sub-channels. In step 506, the MS selects one or multiple sub-channels according to a preset criterion. Herein, the MS may preferably select the predetermined number of sub-channels from among the sub-channels sequentially arranged according to the channel quality. That is, when the number of sub-channels selected by the MSS for being fedback to the BS is three, the MS selects three highly-ranked sub-channels having good channel quality, and feeds back channel quality information for the selected sub-channels to the BS. In another embodiment, the MS may select all sub-channels having channel quality satisfying a reference critical value. In step 508, the MS feeds back quality information for said at least one selected sub-channel to the BS.

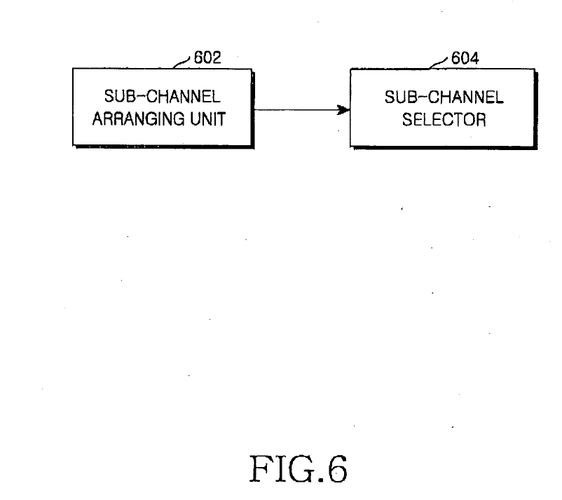

FIG. 6 is a block diagram illustrating the structure of the channel filter 216. Referring to FIG. 6, the channel filter 216 includes a sub-channel arranging unit 602 and a sub-channel selector 604. The sub-channel arranging unit 602 receives measured values for each sub-channel measured by the channel estimator 214, and sequentially arranges the sub-channels in such a manner that a sub-channel having good channel quality precedes any other sub-channels. The sub-channel selector 604 receives information for arrangement by the sub-channel arranging unit 602, selects at least one sub-channel, and transmits channel quality information-related information such as the information and a CINR value to the channel quality information transmitting unit 218.

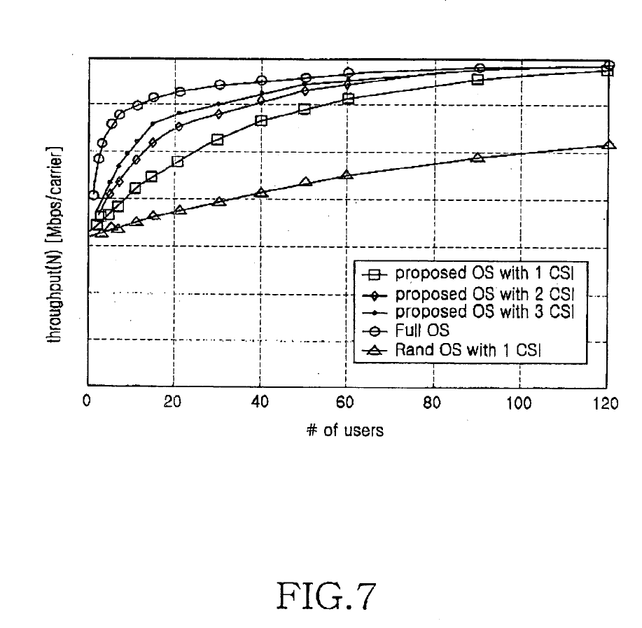

FIG. 7 is a graph which illustrates a comparison of transmission performance between an existing scheme and a scheme proposed by the present invention when quality information of some sub-channels is fedback.

Referring to FIG. 7, the full OS (Opportunity Scheduling) scheme is a scheduling scheme performed by a BS when each MS measures channel quality information for each sub-carrier or sub-channel and feeds back the measured channel quality information to the BS. The full OS scheme has superior throughput (Mbps/carrier) as compared with other schemes. That is, sub-channels assigned to each MS by the BS have good qualities. However, the full OS scheme has a large amount of information fedback from the MS to the BS as compared with the scheme proposed by the present invention, thereby causing a heavy load in the BS. Accordingly, a performance curve obtained by simulation through the scheme proposed by the present invention converges into the full OS throughput performance curve as the number of MSs increases. That is, when the number of sub-channels fedback from the MSSs is two or three, the performance curve approaches the full OS throughput performance curve.

It is assumed that the number of the MSs is U, the number of sub-channels is S, a period for receiving instant channel information for performing a high speed AMC is T_{f} second, a period for receiving average channel information is Tₛ second, the amount of channel quality information of a random sub-channel is B bit, the amount of information required for reporting a location of a random sub-channel is P bit, and the number of sub-channels fedback from each MS is k. In the existing scheme, a load of a fedback channel is expressed by U×S×B/T_{f} (bps). However, a load of a fedback channel in the present invention is expressed by U×k(B+P)/T_{f}+U×B/Tₛ(bps). Accordingly, when a feedback for average channel conditions is ignored, the load of the fedback channel according to the present invention is reduced to an k(B+P)/S×B(bps) level.

According to the present invention as described above, an MS measures quality information of entire sub-channels, selects one or multiple sub-channels having good quality, and feeds back the selected sub-channels to a BS. Therefore, the BS can maximize performance even though the BS receives a small quantity of channel quality information, similarly to a case where the BS receives channel quality information of all sub-channels.

While the present invention has been shown and described with reference to certain preferred embodiments thereof, it will be understood by those skilled in the art that various changes in form and details may be made therein without departing from the spirit and scope of the present invention as defined by the appended claims.

1. A method for a Mobile Station (MS) to feed back channel quality information in a communication system which divides an entire frequency band into a plurality of sub-carrier bands and includes sub-channels representing a set of a predetermined number of sub-carrier bands, the method comprising the steps of:
measuring channel qualities of the sub-channels;
arranging the sub-channels in a sequence in which a sub-channel having channel quality conditions precedes any other sub-channels;
selecting sub-channels satisfying preset conditions from the arranged sub-channels; and
feeding back channel quality information of the selected sub-channels.

2. The method as claimed in claim 1, wherein the step of selecting the sub-channels comprises a step of selecting sub-channels having a Carrier-to-Interference and Noise Ratio (CINR) larger than a preset CINR from the arranged sub-channels.

3. The method as claimed in claim 1, wherein the step of selecting the sub-channels comprises a step of selecting a predetermined number of sub-channels according to the sequence from the arranged sub-channels.

4. The method as claimed in claim 1, wherein the MS measures channel quality of at least one specific sub-channel determined by an instruction of a base station.

5. The method as claimed in claim 1, wherein the step of measuring the channel qualities of the sub-channels comprises a step of measuring the channel qualities by means of a reference signal transmitted from at least one sub-carrier band.

6. An apparatus to feed back channel quality information in a communication system which divides an entire frequency band into a plurality of sub-carrier bands and includes sub-channels representing a set of a predetermined number of sub-carrier bands, the apparatus comprising:
a channel estimator for measuring channel qualities of the sub-channels;
a sub-channel arranging unit for arranging sub-channels in a sequence in which a sub-channel having channel quality conditions precedes any other sub-channels;
a sub-channel selector for selecting sub-channels satisfying preset conditions from the arranged sub-channels; and
a channel quality information transmitter to feed back channel quality information of the selected sub-channels.

7. The apparatus as claimed in claim 6, wherein the sub-channel selector selects sub-channels having a Carrier-to-Interference and Noise Ratio (CINR) larger than a preset CINR from the arranged sub-channels.

8. The apparatus as claimed in claim 6, wherein the sub-channel selector selects a predetermined number of sub-channels according to the sequence, from the arranged sub-channels.

9. The apparatus as claimed in claim 6, wherein the channel estimator measures channel quality of at least one specific sub-channel determined by an instruction of a base station.

10. The apparatus as claimed in claim 6, wherein the channel estimator measures the channel qualities by means of a reference signal transmitted from at least one sub-carrier band.
